(19) United States
(12) Patent Application Publication
(10) Pub. No.: US 2017/0221165 A1
(43) Pub. Date: Aug. 3, 2017

(54) TECHNOLOGY MULTI-SKILLING FRAMEWORK

(71) Applicant: Accenture Global Solutions Limited, Dublin (IE)

(72) Inventors: Nitin Madhukar SAWANT, Mumbai (IN); Prakasam KALATHURU, Sullurpeta (IN); Unmesh SALGAONKAR, Mumbai (IN); Mohan SEKHAR, Bangalore (IN); Shantiprakash Harbuxrai MOTWANI, Thane (West) (IN); Jayant SWAMY, Bangalore (IN); Sanjeev VOHRA, Bangalore (IN)

(73) Assignee: Accenture Global Solutions Limited, Dublin (IE)

(21) Appl. No.: 15/416,984

(22) Filed: Jan. 26, 2017

(30) Foreign Application Priority Data
Jan. 30, 2016 (IN) 201641003393

(51) Int. Cl. G06Q 50/20; G06Q 10/10

(52) U.S. Cl. CPC G06Q 50/2057; G06Q 10/10

(57) ABSTRACT

A comprehensive multi-skilling framework system provides technology tailored for managing and staffing multi-skilled IT professionals. Multi-skill data and proficiencies generated for each individual user are defined, enabled, measured and tracked in the multi-skilling framework. An automated multi-skilling manager receives data that defines technical platforms and a plurality of multi-skill roles within each technical platform. Multiple skills are associated with each multi-skill role and each user is mapped to a multi-skill role. An overall proficiency level that pertains to a user's respective multi-skill role is determined based on multi-skill assessment data for the user. By assigning a multi-skill role to each user and automatically generating a unique proficiency level for each user based on their multi-skill role information, the process of staffing IT projects from large populations of IT professionals is streamlined and conserves processing resources.

### PRIORITY CLAIM

This application claims priority to Provisional Indian Patent Application No. 201641003393, filed on Jan. 30, 2016 (Attorney Docket No. 15718-13), titled “TECHNOLOGY MULTI-SKILLING FRAMEWORK,” which is incorporated herein by reference in its entirety.

### BACKGROUND

Technical Field

The disclosure relates to the field of computer resource management, and more particularly, it relates to techniques for managing compound computer resources using multi-skilling framework tool.

Related Art

The complex and rapidly changing technology used by today's work force imposes significant technical challenges when attempting to develop and deploy an effective and efficient skilled staff. For example, a vast array of evolving and disruptive technologies is used by skilled information technology (IT) professionals for planning and developing software solutions. Each IT technology may require a different configuration of skill sets. The process of monitoring and managing data for training and staffing of skilled resources when hundreds, thousands or tens of thousands of IT professionals are employed, is costly, time consuming and often inefficient. Current tools waste valuable computing resources by failing to efficiently manage the complexity of issues involved in developing and deploying today's workforce. Moreover, without proper controls, IT professionals may invest significant time and money in obtaining a skill or expertise in a particular technology only to find that it is out of date or has little or no use to clients. Today's IT projects utilize various skill sets and a variety of IT technologies. However, when an employee lacks some of the needed skills for a job, additional resources may need to be assigned and an associated expense may be incurred. Accordingly, improved machines and systems for controlling IT projects and skilled resources are desirable.

### BRIEF DESCRIPTION OF THE DRAWINGS

FIG. 1 illustrates an exemplary multi-skilling system comprising a multi-skilling machine for executing processes according to a multi-skilling framework.

FIG. 2 illustrates an example of a specific multi-skilling system implementation for a multi-skilling machine.

FIG. 3 is a flow chart of exemplary steps for implementation of a method by a multi-skilling machine and/or system.

FIG. 4 is a flow chart comprising exemplary steps for data flow and utilization of a multi-skilling system.

FIG. 5 is an illustration of an exemplary multi-skilling data system comprising stored multi-skilling data and associations according to a multi-skilling framework.

FIG. 6 is an illustration of an exemplary user interactive GUI screen for viewing or editing core skills, mandatory skills and elective skills in a multi-skilling framework.

FIG. 7 is an illustration of an exemplary user interactive GUI screen for editing core skills in a multi-skilling framework.

FIG. 8 is an illustration of an exemplary user interactive GUI screen for configuring multi-skill roles in a multi-skilling frame work.

FIG. 9 is an illustration of an exemplary user interactive GUI screen for mapping skill assessment scores and experience to proficiency levels in a multi-skilling frame work.

FIG. 10 is an illustration of an exemplary user interactive GUI screen for configuring weighting parameters for proficiency determination factors in one or more skills.

FIG. 11 is an illustration of an exemplary user interactive GUI screen for display of a participant's multi-skill profile.

FIG. 12 is an illustration of a GUI window displays details of a proficiency level and technical scores.

### DETAILED DESCRIPTION

The information technology (IT) landscape is constantly undergoing significant and disruptive changes. Powerful emerging technologies have opened up new possibilities and ways of developing software in better and faster ways. These changes prompt IT professionals to learn and acquire new technology skills at a very rapid pace. By mastering new technologies, IT professionals become more market relevant and may deliver software solutions to clients speedily and with high quality.

A system architecture is provided for building a robust, yet flexible “multi-skilling” framework. The multi-skilling framework conserves computing time and resources utilized for development and deployment of an ever evolving multi-skilled workforce. The multi-skilling framework enables definition of a multi-skilled role for each individual working in a specified technology platform.

The multi-skilling framework may comprise a user interactive and configurable environment of hardware and software that includes a comprehensive proficiency model. The multi-skilling framework functions as a tool for management of multi-skilled employee development and deployment. The multi-skilling framework defines, enables, measures and tracks a proficiency level determined over a plurality of skills for each individual participant. Within the multi-skilling framework, various technology platforms may be defined and each platform may be associated with a plurality of multi-skill roles. A technology platform and a specific multi-skill role may be assigned to each participant (for example, an individual, user or employee included in a multi-skilling system). Each technology specific multi-skill role may be associated with a plurality of skills that may be mapped to a technology platform level, a multi-skill role level or an individual participant level. For example, technology platforms, multi-skill roles and individual participants may correspond to core skills, mandatory skills and elective skills respectively. In multi-skilling systems, a comprehensive proficiency model may incorporate skill assessment data and a weighted total proficiency level for each participant. The proficiency level of a participant may be determined based on multiple skills and skill based contributions made by the participant to an organization. Assessments may be taken to determine each participant's skill level. In some embodiments, various skills, skill assessments and other proficiency determination factors may be weighted when proficiency level is calculated. A weighted total proficiency level that is determined for a participant's multi-skilled role may validate that the participant possesses the multi-skill proficiencies needed for their specified multi-skill role. In some embodiments, the multi-skilling framework may be referred to as a multi-skilling manager or a multi-skilling management tool.

A multi-skilled individual may be assigned a role on a project team that utilizes a specified technology platform where multiple skill sets may be dynamically assigned to the role in the multi-skilling framework. Having employees on hand that are proficient in specified multi-skill roles enhances a service organization's ability to meet client demands for staffing into rapidly changing skill profiles. This multi-skilling framework may foster a culture of technology excellence, where new ideas, innovative solutions, and high quality technical deliverables may be recognized and celebrated. The flexibility built into this multi-skilling framework may accommodate the rapid changes in technology and provide for a continuous learning experience to the multi-skilled participants.

The multi-skilling framework is configurable to track at least several thousands of multi-skilled technology professionals across a vast spectrum of technology platforms. For example, technology platforms may include Java, .net, Oracle, SAP, SFDC, Microsoft, Testing, Digital, IBM, Salesforce, Pega, Workday and SCM. In some embodiments, a technology platform may be referred to as a capability. Also, a multi-skill role may be referred to as a multi-skill group, a role specialization, a specialty or function, for example.

However, the multi-skilling framework is not limited to application in IT technical professions and may be utilized for other types of professions or employees with other types of multi-skill roles, such as project managers, product managers, sales force representatives, teachers, marketing managers, executives and so on. For example, rather than a technology platform, any type of knowledge platform, capability or area of expertise of a non-technical nature may be defined and implemented in the multi-skilling framework. In some embodiments of the multi-skilling framework, skills for a given platform may comprise, for example, communication skills including written, verbal or pubic speaking skills, organization skills or executive skills. The multi-skilling framework application is not limited with regard to any specific types of capability platforms or multi-skill roles.

Benefits for the participants of the multi-skilling framework may include participation in the newly defined multi-skilled roles. For example, participants who demonstrate a high level of multi-skilled proficiency may be selected for technically complex and challenging assignments that may provide them with a rich experience to further enhance their skills. This process may lead to better career opportunities where the latest technology skills may open up new career opportunities and improve career growth prospects for the participants. Formal vendor certifications and other valuable credentials and rewards may be provided to participants who successfully complete a multi-skilling program.

Additionally, a multi-skilled workforce provides valuable benefits to service organizations and to their clients. For example, project teams may be leaner, comprising fewer people with a greater number of skills. Overall technological solutions may be more cost-competitive due to staffing of the multi-skilled team members. The multi-skilling framework may enable a service organization to easily place the multi-skilled technologists in client facing positions and deliver projects to the clients with leaner, flexible, and more agile teams for handling complex technology roles.

Furthermore, by deploying the multi-skilling framework, thought leadership may be enhanced in the latest technology areas through, for example, point of view deliverables (PoVs), demonstrations, prototypes, new assets and offerings to clients. Such a progressive approach may foster a culture of technology excellence within a service organization where new ideas, innovative solutions and high quality deliverables may be recognized and celebrated, all of which may provide a vibrant environment for the highly talented multi-skilled technologists. This may, in turn, attract technology talent and reduce attrition within the technology work stream.

In some embodiments, a “multi-skilling” framework may be created based on analysis of patterns and trends in client staffing demands and roles and activities performed by individuals deployed in a workforce or on project teams.

The multi-skilling framework may define specific multi-skill roles for the participants. For example, in an information technology multi-skilling framework, a number of multi-skill roles or areas of expertise may be defined for a particular type of technology that may be referred to as a technology platform. In some systems, the multi-skill roles may be defined based on client requirements, changing technologies and work profiles of a technology workforce.

Initially, each individual or employee participant may be assigned a multi-skill role within a specified technology platform or area of expertise. In some embodiments, a multi-skill role assignment may be based on an individual's current skills. For example, in a specified technology platform, one type of multi-skill role may be defined as an “application developer” that may have responsibilities for performing development of a back-end application including a core application, data access, business logic, batches and so on. A “user interface (UI) developer” multi-skill role may include responsibilities for development of front-end screens and a user interface. An “integration developer” multi-skill role may include responsibilities for development of interfaces of an application with external systems. An “operations engineer” multi-skill role may include set-up, configuration, maintenance and support of various environments, tools, servers and databases. An “application architect” multi-skill role may include understanding functional and non-functional system requirements, design of architecture frameworks and environments, and definition of tools and technologies to be used for application development.

Multi-skill role definitions may vary over different technology platforms or areas of expertise. Moreover, a technology platform may have multi-skill roles specific to that platform alone. For example, Pega may have a specifically defined “report developer” multi-skill role.

Each multi-skill role in a technology platform or area of expertise may be associated with multiple skills that may be utilized by individuals to perform the multi-skill role. The multiple skills may be characterized, for example, according to their utility in performing the multi-skill role or working within the particular technology platform. In one embodiment, skills that may be characterized or classified as “core skills” may be associated with all the multi-skill roles that fall within a particular technology platform or area of expertise. All individuals assigned to the constituent multi-skill roles in that particular technology platform may be assessed relative to some level of proficiency in the core skills. Moreover, skills characterized or classified as “mandatory skills” may be associated with a particular multi-skill role. All individuals assigned to that particular multi-skill role are expected to have some level of proficiency in the mandatory skills. Furthermore, some skills that may not fall under one of the skill classifications of core or mandatory may be considered elective skills. For example, a user may enter skills that they possess into the multi-skilling framework as elective skills. These elective skills may fall outside of the identified core and mandatory skills of the user's assigned platform and multi-skill role.

In some embodiments of a multi-skilling framework, core skills may comprise fundamental software development skills that are relevant or “core” to all roles within a technology platform or an area of expertise, or in some instances, core to all specified technology platforms. Individuals or participants defined within the multi-skilling framework may need to acquire a specified level of proficiency or competency in the core skills. Some examples of a core skill include a programming Language, for example, Java, C# or ABAP; a scripting language, for example, Javascript, Scala or Python; an operating system (OS), for example, Windows or Linux; and a procedural language or structured query language (PL-SQL), for example, in Oracle database, TimesTen in-memory database, and IBM DB2.

In some embodiments of a multi-skilling framework each multi-skill role may have a number of mandatory skills defined. These mandatory skills may be utilized in day-to-day work performed for that particular multi-skill role based on the technologies that are commonly used in performing that role. Moreover, participants may be encouraged to acquire additional elective skills that may be useful or utilized in some projects.

Table 1 represents an exemplary association between data identifying a multi-skill role, data identifying an individual (user A) and data identifying multiple skills including core skills, mandatory skills and elective skills associated with the individual.

TABLE 1

| | | |
|---|---|---|
| Technology | Multi-Skill | Core Skills |
| Platform | Role 1 - User A | Programing language - skill 1 |
| | | Operating System - skill 2 |
| | | PL-SQL - skill 3 |
| | | Scripting language - skill 4 |
| | | Mandatory Skills |
| | | skill 5 |
| | | skill 6 |
| | | Elective Skills |
| | | skill 7 |
| | | skill 8 |

In an exemplary use case of the multi-skilling framework, an organization may offer participants or employees one or more ways to develop their proficiency in one or more skills. Through the multi-skilling framework, skills training may be prescribed and recommended to each of the participants based on their multi-skill role and skill assessments. For example, participants may go through skills training or participate in skill building activities. The organization may take into consideration information from skill competency or proficiency assessments of the participants or allow the participants to demonstrate their proficiency in other ways. The information may be processed in the multi-skilling framework, where skill assessments may be utilized to generate skill proficiencies that may be utilized to determine a role based proficiency level for each participant in the multi-skilling framework.

In one embodiment, a participant may be registered in the multi-skilling framework for a particular multi-skill role and associated technology platform. The participant may be assessed relative to a plurality of skills that are associated with the multi-skill role. The multi-skilling framework may generate a proficiency level for the participant based on the skills assessments relative to the multi-skill role. The multi-skilling framework may identify skill deficiencies based on the participant's skills assessments and proficiency level results, and may map the results with training objectives for development in skill deficiencies. The participant may be directed by the multi-skilling framework to undertake various skill training or hands-on assignments that utilize or develop the core, mandatory or elective skills. The participant may undergo further skills assessment or may receive certifications for their skills training.

The skills training may include, for example, online or classroom training as well as participation in various technical forums and other sources. This training may provide conceptual knowledge and various examples of the technologies to the participants. Moreover, the participants may execute hands-on assignments to practice their skills. For example, the participants may write code or build applications in an internet environment such as a PaaS platform like IBM Bluemix. The ready-to-use, pre-configured development environments may allow the participants to focus on writing the code for a case study application. However, the application is not limited in this regard.

Once a participant has acquired skills for their assigned role, the skills may be assessed, for example, using online tests or other methods. The tests may assess the participant's knowledge on core and/or mandatory skills and may include code assessment. In addition, the participants may receive credit in the multi-skilling framework for earning certifications, for example, from software vendors such as SAP, Oracle, Microsoft, Salesforce.com and Pega. Moreover, various events may be conducted to provide forums for participants to demonstrate their technical skills, such as coding contests, quizzes and hackathons. The winners of these events may receive special credit and recognition as technology experts in the multi-skilling framework.

In some embodiments of the multi-skilling framework, a multi-skill proficiency may be determined for a participant relative to a multi-skill role and associated technology platform, based on the multiple skills associated with the multi-skill role. For example, a multi-skill proficiency may pertain to one or more of the core, mandatory and/or elective skills. The multi-skill proficiency may be determined as a function of multiple parameters or factors, which may include, for example, 1) test scores that reflect knowledge and skills associated with a multi-skill role, 2) credit for certifications from software vendors, 3) contributions to an organization, for example, sales support, technical asset creation, presentations, articles in industry forums and thought leadership, and 4) winning proof of skill events, for example, contests, quizzes or hackathons. However, the disclosure is not limited to any particular type of proficiency determination factors.

In some embodiments, a multi-skilling framework may encompass specialized technology skills and competencies required for high-end technology multi-skill roles such as a technology or enterprise “architect.” In addition to providing breadth of skills, a multi-skilling framework may also facilitate rewards for development of deep skills in specialized and niche technologies.

The architecture for the multi-skilling framework aims to achieve a paradigm shift in the technology used to develop, measure, and reward employees in order to provide a well-structured technological and convenient approach to staffing multi-skilled individuals in a rapidly changing technological environment. These ends may be reached by 1) configuring multi-skill roles and multiple skills associated with each of the multi-skill roles, 2) assigning a multi-skill role to each participant and 3) providing a multi-skilling framework to determine a proficiency level for each participant based on skills assessments associated with their multi-skill role. The skills assessments may be based on multiple criteria that validate each participant's knowledge and hands-on skills. The multi-skilling framework provides an effective, robust and yet flexible mechanism to define, impart and assess the skills of a large multi-skilled technology workforce.

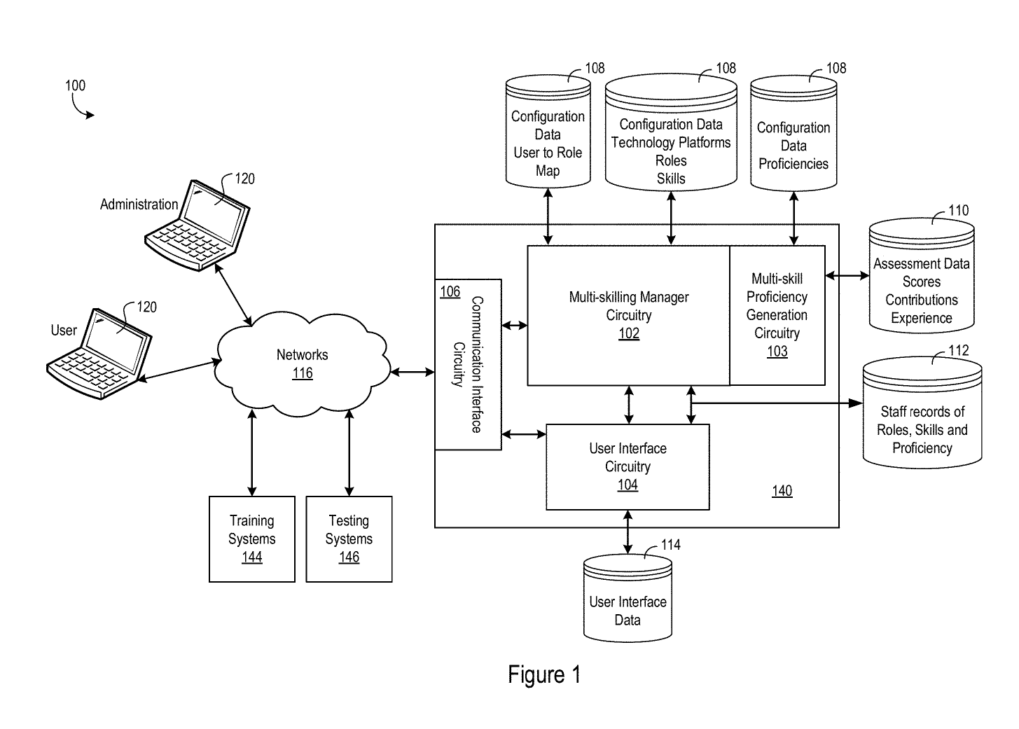

Referring now to the figures, FIG. 1 illustrates an exemplary multi-skilling system 100 comprising a machine 140 for executing processes according to a multi-skilling framework. The machine 140 may include suitable logic, circuitry, processors and/or code, for example, a multi-skilling manager circuitry (MS manager circuitry) 102, a multi-skill proficiency generation circuitry 103, a user interface circuitry 104, and a communication interface circuitry 106. In some embodiments, the machine 140 may comprise a device with one or more processors that perform the functions of the multi-skilling manager circuitry 102, the multi-skill proficiency generation circuitry 103, the user interface circuitry 104, and the communication interface circuitry 106.

The system 100 may also include one or more storage devices, for example, a suitable memory device or hard drive, which may store one or more databases. The one or more databases may include a configuration database 108 for storage of and access to configuration data or operational parameters for implementing a multi-skilling framework by the multi-skilling manager 102. The configuration database 108 may include data that identifies and/or defines participants, technology platforms, multi-skill roles, skills, participant to multi-skill role maps, proficiency determination factors, proficiency weighting and threshold parameters and participant's proficiency levels, for example. A participant assessment database 110 for storage of and access to participant assessment data may include, for example, skills test scores, demonstrated skills information, professional contributions information and participant work experience information. A staff records database 112 may be utilized for storage and access to output from the multi-skilling manager 102 and the multi-skill proficiency generation circuitry 103. Furthermore, system 100 may include a user interface database 114 for storage of and access to user interface or graphical user interface (GUI) data for the multi-skilling framework. The one or more databases 108, 110, 112 and 114 may comprise one or more separate or distinct databases or a common database comprising all of the recited data stored in the one or more databases 108, 110, 112 and 114.

The one or more databases 108, 110, 112 and 114 including the configuration database 108, participant assessment database 110, staff records database 112 and the user interface database 114 may be stored on the one or more memory devices, for example, on multiple distinct storage devices, a single storage device, or a combination thereof. For example, some of the databases 108, 110, 112 and 114 may be implemented on a common shared storage device, while other of the databases 108, 110, 112 and 114 may be implemented on one or more other distinct storage devices. These storage devices may be local to the machine 140, for example, housed within the machine 140 or directly connected to the machine 140. Alternatively, these storage devices may be remote, for example, a remote database 112 may be connected to the machine 140 over one or more networks 116 such as an intranet (e.g., local) or via the Internet.

Data and metadata may be imported into the multiskilling framework databases utilizing spreadsheets, text or any suitable method. Alternatively, data may be entered into the databases by user input via a graphical user interface. In some embodiments data associations among the stored data may be specified by GUI screen input. Various data items may be associated within the multi-skilling system based on database storage locations, data structures within the stored data and other stored data association indicators.

The multi-skilling manager circuitry 102 may be coupled to the multi-skill proficiency generation circuitry 103. The multi-skilling manager circuitry 102 and the multi-skill proficiency generation circuitry 103 may comprise multiple separate and distinct units of circuitry or hardware processors, or may comprise a sole or compound unit of circuitry or hardware processor. In some systems 100, the multi-skilling manager circuitry 102 and the multi-skill proficiency generation circuitry 103 may reside on distributed computer systems coupled via the network 116. The multi-skilling manager circuitry 102 and the multi-skill proficiency generation circuitry 103 may be coupled to the user interface circuitry 104 and the communication interface circuitry 106, while the user interface circuitry 104 may also be coupled to the communication interface circuitry 106. The machine 140, and in particular, the multi-skilling manager circuitry 102 may be coupled to the one or more one or more storage devices and the one or more databases including the configuration database 108, participant assessment database 110, staff records database 112 and the user interface database 114.

The user interface circuitry 104 may be coupled to a user interface database 120, which may store logic, instructions, code, images, or other content necessary to generate and provide a user interface, and in particular, a graphical user interface (GUI) that may be communicated via the one or more networks 116 and displayed on one or more client devices 120. The GUI may be utilized for configuring the multi-skilling framework, uploading data files or inputting data via a browser screen. Furthermore, the GUI may be utilized to register participants in a multi-skilling program, present participant information to the participants or to management or administrators of the multi-skilling program. For example, the GUI may be used for determining the status of a participant, including technology platform, multi-skill role, skills, proficiency or certifications, determining recommended training for a participant, or sourcing participants for staffing of projects or employment positions.

The machine 140 may be coupled to one or more networks 116, which may include any suitable wireless or wireline network and may include the Internet or an intranet. Other devices and/or systems may also be connected to the networks 116, including, for example, the one or more client devices 120. The one or more client devices 120 may include, for example, a computer (e.g., laptop), a smartphone, or another electronic device capable of communicating with the machine 140 via the networks 116 or directly. The one or more client devices 120 may comprise a computing device that allows a user to connect to a network 116, such as the Internet. Examples of a client device 120 include, but are not limited to, a personal computer, personal digital assistant (“PDA”), a laptop, a smartphone, a cellular phone, a tablet, or another electronic device. The one or more client devices 120 may include a keyboard, keypad, a touch screen interface, or a cursor control device, such as a mouse, or a joystick, a display device, a remote control, and/or any other device operative to view and interact with a user interface. In one embodiment, the client device 120 is configured to request and receive information from the networks 116, for example, using a web browser, such as INTERNET EXPLORER® (sold by Microsoft Corp., Redmond, Wash.) or FIREFOX® (provided by Mozilla). Alternatively, the client device 120 may couple directly to the machine 140 (e.g., via a direct connection or via a local intranet). In another embodiment, the client device 120 and the machine 140 are implemented on the same system, e.g., on a laptop or other computing device. Further technical operational details of the machine 140 are provided below.

One or more third party training systems 144 and testing systems 146 may be communicatively coupled to the machine 140 and/or the one or more client devices 120. The third party training systems 144 and testing systems 146 may enable participants of the multi-skilling program to register for training and take online training or tests using the one or more client devices 120. The training and tests may be prescribed for participants by the multi-skilling manager 102 in order for the participants to develop proficiencies in their assigned multi-skilled role.

In operation, the multi-skilling manager circuitry 102 may receive configuration data that defines a plurality of technology platforms (or capabilities), a plurality of technology specific multi-skill roles, a plurality of multi-skill role and/or technology specific skills, user to multi-skill role associations or assignments and multi-skill role specific proficiency determination parameters. For example, the configuration data and any other data utilized in the multi-skilling system 100 may be imported utilizing spreadsheets, such as EXCEL® spreadsheets. Moreover, the data may be imported as text, however, the application is not limited in this regard and any suitable method may be utilized to import or enter data into the multi-skilling system 100. Configuration data items may be associated within the multi-skilling system according to database storage of the configuration data items as specified in a spreadsheet, or by other association indicators stored in the system. Moreover, the configuration data may be entered, removed, associated and or modified in the multi-skilling framework system by user entry in a graphical user interface.

The multi-skilling manager circuitry 102 may store the configuration data in the one or more configuration databases 108. The multi-skilling manager circuitry 102 may receive participant assessment data including participant test scores from the testing system 146; certifications earned by the participants from the training system 144 and participant contribution data and/or hands-on experience data from the one or more client devices 120, and may store the assessment data in the participant assessment database 110.

The multi-skilling manager 102 may request that the multi-skill proficiency generation circuitry 103 determine a multi-skill role proficiency level for one or more participants of the multiskilling program. In this regard, the multi-skill proficiency generation circuitry 103 may retrieve technology platform, multi-skill role and skills data for the participants from the one or more configuration databases 108. Assessment data may be retrieved from the assessment data base 110. Proficiency determination factors and parameters may be retrieved from the configuration database 108 and the multi-skill proficiency generation circuitry 103 may generate a total proficiency level of each participant based on their respectively assigned multi-skill role, associated skills, assessment information and proficiency determination parameters and thresholds. The total proficiency levels for the participants may be stored in the database 112.

The multi-skilling manager circuitry 102 may receive a request for status of a participant or for multi-skilling framework data corresponding to one or more participants enrolled in a multi-skilling program. The request may be received from the one or more client devices 120. The multi-skilling manager circuitry 102 may generate reports based on the participant data stored in the configuration database 108, participant assessment database 110, staff records database 112 and the user interface database 114, or may generate new data for a response to the request. Furthermore, the generated reports and/or participant data retrieved from the databases 108, 110, 112 and 114 may be presented in one or more GUI screens generated by the user interface circuit 104 and sent to one or more of the client devices 120 for display.

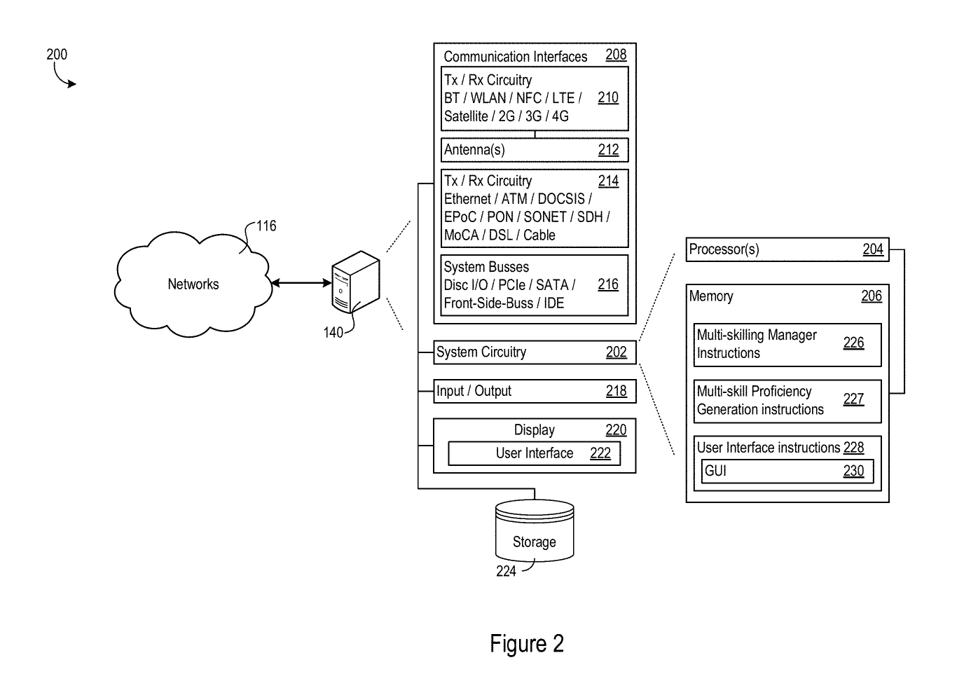

FIG. 2 illustrates an example of a specific multi-skilling system implementation 200 for the multi-skilling machine 140. According to the system implementation 200, the machine 140 includes system circuitry 202 to support implementation of the various circuitry elements and multi-skilling framework functions discussed with respect to FIGS. 1-12. In one embodiment, the system circuitry 202 includes one or more processors 204, memory 206, and/or other circuitry. The one or more processors 204 may be connected to the memory 206 that may comprise a memory system including a plurality of memory devices collocated with the one or more processors 204 or distributed across multiple systems. The memory 206 may store multi-skilling framework control instructions, operational parameters for the control instructions, datasets, and other information described with respect to FIGS. 1-12. The control instructions may be executed by the one or more processors 204 to implement a multi-skilling framework and any of the processing described herein, according to a configuration set by operational parameters stored in one or more of the configuration database 108, the participant assessment database 110, the staff records database 112 and the user interface database 114. Furthermore, in some embodiments, various circuitry elements of the machine 140 may be implemented by the system circuitry 202. For example, the multi-skilling manager circuitry 102, the multi-skill proficiency generation circuitry 103, the user interface circuitry 104, and the communication interface circuitry 106, may be implemented in whole or in part by one or more instances of the system circuitry 202.

The memory 206 may store data and instructions for use by the circuitry elements and/or to implement portions of the circuitry elements. In one embodiment, the memory 206 may include multi-skilling manager instructions 226. The processors 204, memory 206, and multi-skilling manager instructions 226 may implement portions of the multi-skilling manager circuitry 102 shown in FIG. 1. The memory 206 includes multi-skill proficiency generation instructions 227. The processors 204, memory 206, and multi-skill proficiency generation instructions 227 may implement portions of the multi-skill proficiency generation circuitry 103 shown in FIG. 1. Similarly, the memory 206 may include user interface instructions 228, which may further include graphical user interface (GUI) instructions and data 230. The processors 204, memory 206, user interface instructions 228 and GUI instructions and data 230 may implement portions of the user interface circuitry 104 shown in FIG. 1.

The machine 140 may also include communication interfaces 208, which may support wireless communication via wireless communication circuitry 210 and antennas 212. Some examples of wireless communication protocols utilized by a multi-skilling framework may include Bluetooth, Wi-Fi, WLAN, near field communication protocols, cellular protocols (2G, 3G, 4G, LTE/A), and/or other wireless protocols. Also, communication interface 208 may include wired communication circuitry 214. Example wired communication protocols may include Ethernet, Gigabit Ethernet, asynchronous transfer mode protocols, passive and synchronous optical networking protocols, Data Over Cable Service Interface Specification (DOCSIS) protocols, EPOC protocols, synchronous digital hierarchy (SDH) protocols, Multimedia over coax alliance (MoCA) protocols, digital subscriber line (DSL) protocols, cable communication protocols, and/or other networks and network protocols. The communication interfaces 208 may be connected or configured to be connect to the networks 116, including any suitable wireless or wireline network, the Internet or an intranet, to enable the machine 140 and the system circuitry 202 therein to communicate with other systems and devices. Additionally, the communication interface 208 may include system buses 216 to effect intercommunication between various elements, components, and circuitry portions of the machine 140. Example system bus implementations include PCIe, SATA, and IDE based buses. However, the multi-skilling framework system is not limited to any specific types of communication technology.

The communication interfaces 208 may enable interconnection of various circuitry components illustrated in FIG. 1 within the machine 140 (e.g., via one or more buses, computer component interfaces, or peripheral component interfaces). For example, the communication interfaces 208 may couple to the multi-skilling manager circuitry 102, the multi-skill proficiency generation circuitry 103 and the user interface circuitry 104. Further, the communication interfaces 208 may couple to one or more of the configuration database 108, the participant assessment database 110, the staff records database 112 and the user interface database 114, internally via system busses 216 if internally maintained, or externally via the wireless communication circuitry 210 or the wired communication circuitry 214 if externally maintained.

The communication interfaces 208 may support communication with the one or more external client devices 120 and the third party training systems 144 and testing systems 146. Communication with the external one or more client devices 120 and the third party training systems 144 and testing systems 146 may be effected through user interface circuitry 104 and/or with user interface instructions 228.

A dynamically reconfigurable GUI may be provided to the external one or more client devices 120 and the third party training systems 144 and testing systems 146 via the networks 116 to enable interaction between the one or more client devices 120 and the machine 140 and the third party training systems 144 and testing systems 146 and the machine 140. In one example, the machine 140 comprises a web server capable of providing web services or web pages to the one or more client device 120 and the third party training systems 144 and testing systems 146.

In some embodiments, the machine 140 may itself include various I/O interfaces 218 and/or a display 220, for example, to enable local interaction with the various circuitry elements discussed above instead of or in addition to interaction over the networks 116 with a remote client device 120. In some examples, the display device 220 can provide a user interface 222 to a local user, which can be the same as or a variation of a user interface that can be provided to a remote client device 120 (discussed below).

Additionally, the I/O interfaces 218 and display 220 may enable local maintenance engineers to interact with the machine 140. A local GUI may be provided via the local display 220 to present a control dashboard, actionable insights and/or other information to a maintenance engineer. The local GUI may support portable access, such as, via a web-based GUI, to enable maintenance on the machine 140 or other interaction with the machine 140. This local GUI may be the same as or different from the GUI described elsewhere. The machine 140 may also include a storage drive 224 (e.g., a hard drive, solid-state drive, or other memory system) to enable local storage of system software, user interfaces, or system instructions.

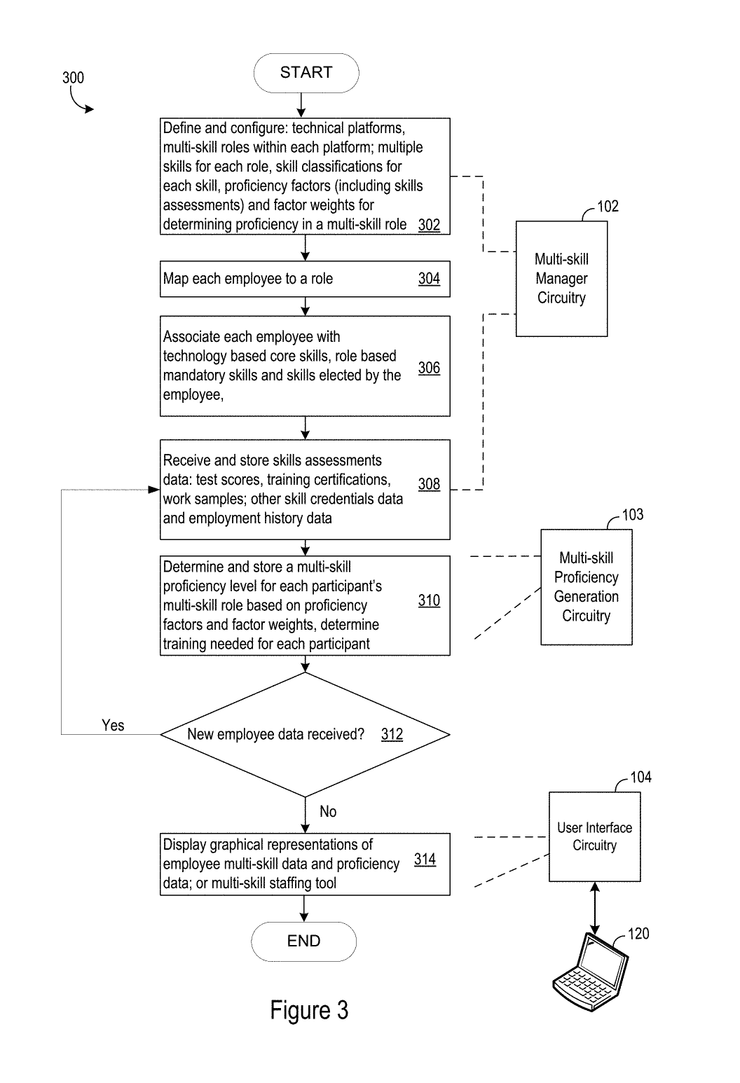

FIG. 3 is a flow chart of exemplary steps for implementation of a method by a multi-skilling framework machine 140 and system 100. The exemplary steps 300 provide for a comprehensive proficiency model that defines, enables, measures and tracks multi-skill proficiencies for participants in a multi-skilling program. The logic 300 further enables staffing tools for appropriately placing the multi-skilled participants in multi-skilled employment roles or positions. In some embodiments the multi-skilling manager circuitry 102 may be configured to implement exemplary steps 302-308 and 312, the multi-skill proficiency generation circuitry 103 may be configured to implement exemplary step 310 and the user interface circuitry 104 may be configured to implement exemplary step 314. However, the system is not limited with respect to which circuitry performs the steps of FIG. 3.

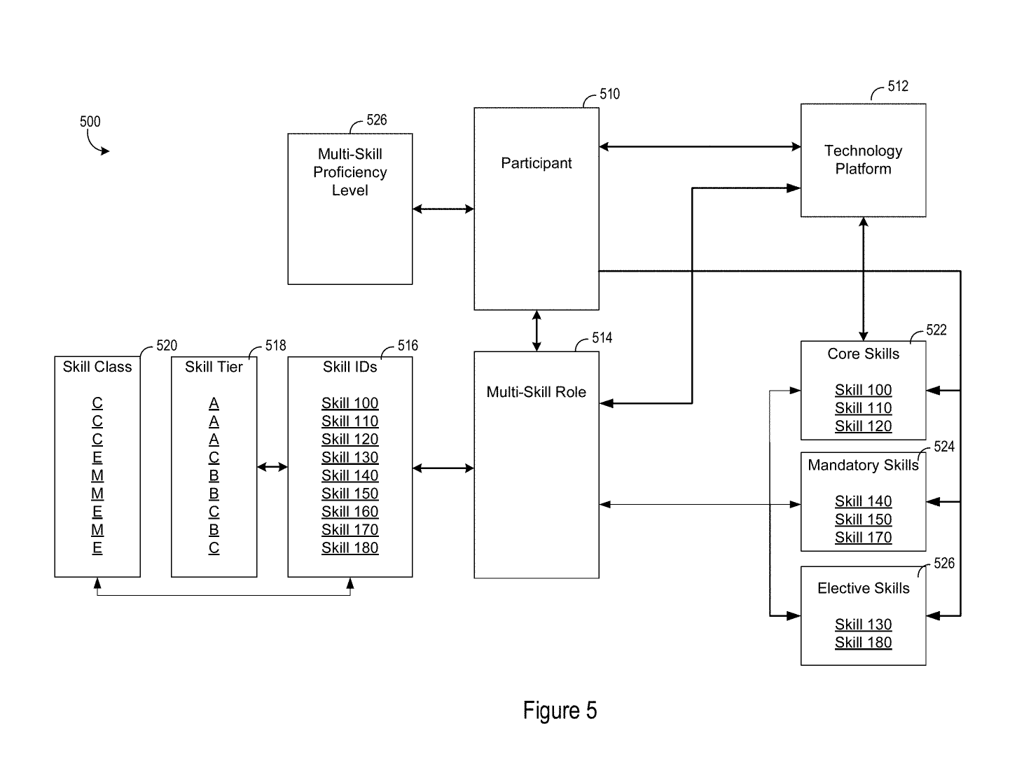

In exemplary step 302, various definitions and configuration data may be imported into the machine 140 and stored in one or more storage devices comprising the databases 108, 110, 112 and 114 shown in FIG. 1. Data associations may be defined. Definitions and parameters for technology platforms, multi-skill roles or role specializations and skills may be imported in bulk or entered by a user via a user interface into the appropriate databases 108, 110, 112 and 114, for example, as described with respect to FIGS. 5 through 12.

A plurality of technology platforms may be defined and for each of the technology platforms a respective plurality of multi-skill roles may be defined and associated with the technology platform. Furthermore, multiple skills may be defined and a plurality of the multiple skills may be associated with each of the multi-skill roles. Each of the multiple skills may be imported with various metadata that may classify or prioritize the skills. Furthermore, factors that may be utilized for determining a user's proficiency level in a multi-skill role and respective weightings and thresholds for the proficiency determination factors may be imported and stored. In some embodiments the proficiency factors may include various types of skills assessment data.

In one example of step 302, technology platform data may be imported and stored in one or more of the databases 108, 110, 112 and 114. The technology platform data may include, without limitation, information regarding: Java, .net, Oracle, SAP, SFDC, Microsoft, Testing, Digital, IBM, Salesforce, Pega, Workday and SCM. The Java technology platform may be associated with multiple multi-skill roles including, for example: Application Architect, Application Developer, Front-end Developer, Integration Developer and Operations Engineer. The technology platform may also be associated with “core” skills including: J2EE, Design Patter and UML. Each multiskill role within a technology platform may be associated with a number of mandatory skills. For example, the Java technology platform multi-skill role “Application Developer” may be associated with a plurality of skills including Java EE, Spring and Hibernate that may be classified as “mandatory” for the Application Developer role, while Jasper Reports and iBatis may be classified as “electives.” However, the disclosure is not limited with respect to any specific technology platforms, multi-skill roles or skills.

A user interface may be utilized to import, enter or modify multi-skilling framework data including, for example, data for technology platforms, multi-skill roles, skills, participants and proficiency determination information that may include factors used in calculating a participant's proficiency and further parameters such as weighting values and numerical range thresholds that may be applied to proficiency determination factors for the proficiency level calculation.

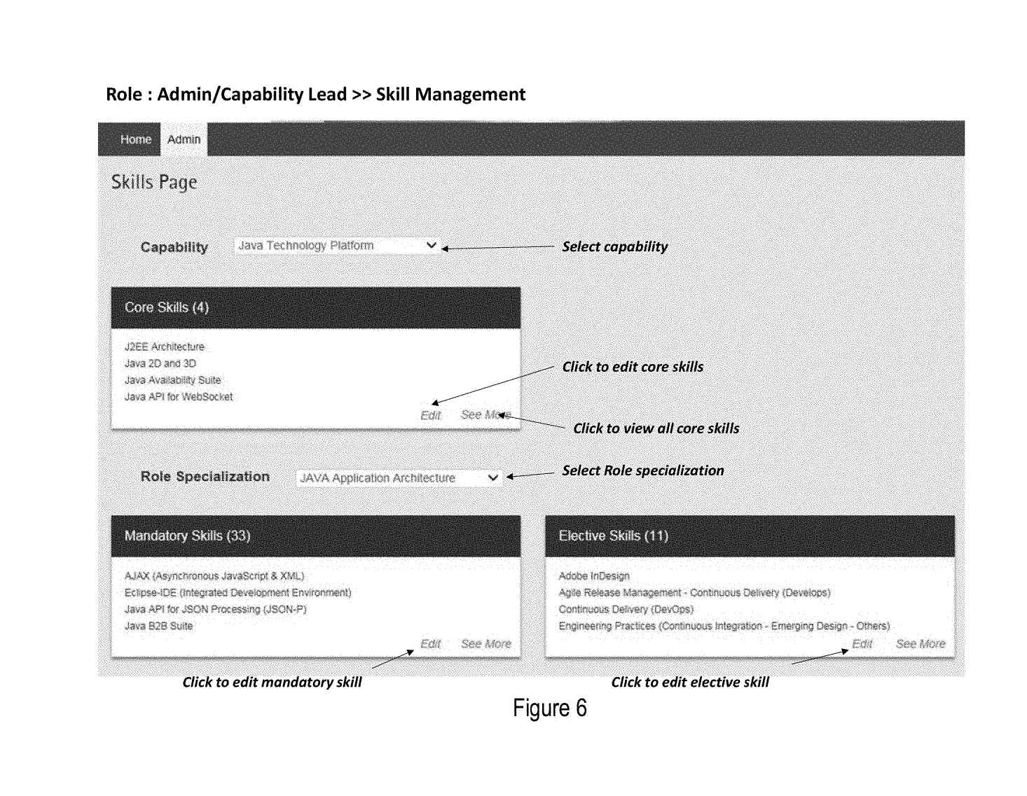

A graphical user interface (GUI) may be generated and provided to users to enable users to configure or modify the multi-skilling framework data. In some embodiments, the GUI may be used to assign multi-skill roles to technology platforms, to assign multiple skills to multi-skill roles and to assign multi-skill roles to participants. Furthermore, core skills, mandatory skills and elective skills may be defined and associated with technology platforms, multi-skill roles and participant's respectively. Examples of interactive GUI screens for a multi-skilling framework are described with respect to FIGS. 6-12. In exemplary step 304, data that maps each employee or participant to one of the multi-skill roles may be imported and stored.

In exemplary step 306, each employee or participant may be associated with a plurality of skills that may be classified as core skills, mandatory skills or elected skills. In some embodiments, a participant may select their own elective skills.

In exemplary step 308, skill assessment data for each participant may be imported or input. For example, test scores from testing system 146 and training certifications from training systems 144 may be imported or input by a user. Moreover, data indicating results from hands-on assignments or work samples, a participant's technical contributions to an organization, “hackathons,” or contests may be imported as an assessment of a participant's competency in one or more of their assigned skills.

In exemplary step 310, a total multi-skill proficiency level for each participant is determined based on the proficiency factors and weightings associated with the multi-skill role and the plurality of skills that are assessed for the role. Factors affecting multi-skill proficiency may be configurable per multi-skill role and per technology platform. In one embodiment, multi-skill proficiency factors may include test scores, certifications, technical contributions and hands-on assignments, for example. The proficiency factors may be associated with a multi-skill role and may each be associated with a particular weight when used to determine the total multi-skill proficiency for a participant assigned to that multi-skill role. In some embodiments, the weightings for various different skills or for various assessments of a skill may be different depending on, for example: the years of experience a participant has obtained, which skill or multi-skill role is being assessed, or which type of assessment is being considered.

In one example, a proficiency level for each participant may be calculated based on associations or mappings made among data stored in the databases 108, 110, 112 and 114, or in a spreadsheet. Each stored technology platform may be mapped to (or associated with) one or more multi-skill roles. Each stored multi-skill role may be mapped to a plurality of skills. Each stored participant (or employee) may be mapped to a multi-skill role and a corresponding technology platform. Each participant may be also be mapped to proficiency determination factors, for example, one or more values representing assessment results for a plurality of skills. The assessments results may be based on test scores, contributions and certifications, for example. Other factors such as resume information, years of experience or position grade level may also be stored and associated with a participant as proficiency determination factors. Various stored proficiency determination factors may be identified for a participant and one or more of the factors may be weighted based on stored weight values. In one example, each of a set of weighting values that depend on a participant's employment grade may be applied to the participant's respective skills assessments values, such as skill test scores, technical contributions and skill training certifications. Moreover, each of the skills that are assessed may be weighted for importance or tier in the proficiency determination calculation. A single multi-skill role assessment value may be determined for each participant based on the weighted proficiency factors. A proficiency level may be assigned to the participant based on where the participant's multi-skill role assessment value falls within specified ranges. For example, proficiency levels P4, P3, P2 and P1 may be mapped to multi-skill role assessment thresholds of above 90%, above 75%, above 50% and above 40% respectively. These thresholds may be predefined and/or independently adjusted by an administrator.

In exemplary step 312, in instances when new data is received for a participant, the exemplary steps may proceed to step 308. In instances when no new data is received in step 312, the exemplary steps may proceed to step 314.

In exemplary step 314, one or more reports and graphical representations may be generated and displayed to users for communicating participants' multi-skilling system information. For example, multi-skilling records and statistics, participants' multi-skill proficiency status, recommendations for career or skills development, staffing data and staffing assignment tools may be generated and displayed. For example, web applications may generate multi-skilling displays to be sent to the one or more client devices 120 for use by the multi-skilled participants and administration users in a web browser.

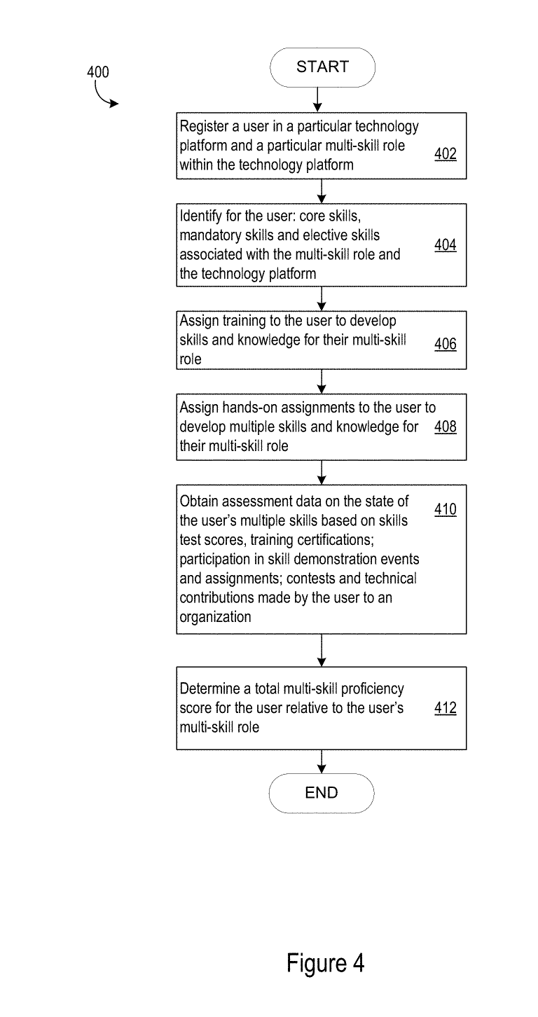

FIG. 4 is a flow chart of exemplary steps for data flow and utilization of a multi-skilling web based or other software generated tool based on a multi-skilling framework and system, for example, as described with respect to FIGS. 1-3. The exemplary steps begin at step 402.

In exemplary step 402, a participant may be registered in a multi-skilling program and assigned a technology platform and a multi-skill role within the technology platform. For example, participant registration data may be imported or entered via a graphical user interface.

In exemplary step 404, core skills and mandatory skills associated with the multi-skill role and the technology platform may be identified and associated with the participant. Elective skills may be associated with the participant.

In exemplary step 406, training may be assigned to the participant to develop skills, knowledge and experience for skills included in their multi-skill role. The training may be assigned based on associations between two or more of training information, the core skills, mandatory skills and/or elective skills stored in the databases and skills assessment data associated with the participant.

In exemplary step 408, hands-on assignments may be assigned to the user to develop multiple skills and knowledge for their multi-skill role. The hands-on assignments may be assigned based on associations between two or more of training information, participant skills assessment data and the core skills, mandatory skills and/or elective skills stored in the databases.

In exemplary step 410, assessment data may be obtained for determination of the state of the user's multiple skills. The assessment data may be based on skills test scores, training certifications, participation in skill demonstration events, hands-on assignments results, contests and technical contributions made by the user to an organization.

In exemplary step 412, a total multi-skill proficiency score may be determined for the participant where factors used for determining the total multi-skill proficiency score may be selected or weighted for the participant's assigned technology platform and multi-skill role as well as for other factors. For example, proficiency determination factors that contribute to the total multi-skill proficiency score may be based on the obtained assessment data. Each factor may be weighted according to respective weight values that may be configured in the multi-skill framework databases.

FIG. 5 is an illustration of an exemplary multi-skilling data system comprising a database storing multi-skilling data and associated data relationship information according to a multi-skilling framework. A multi-skilling data system 500 may include participant data 510, technology platform data 512, multi-skill role data 514, skill identification (ID) data 516, skill tier data 518, skill class data 520, core skills data 522, mandatory skills data 524, elective skills data 524 and multi-skill proficiency level data 526. The multi-skilling data may be stored in one or more memory devices that may include one or more of the databases 108, 110, 112 and 114, for example. In some embodiments, some or all of the illustrated data may be stored in the staff records database 112. The multi-skilling data shown in FIG. 5 may be stored in the one or more memory devices by the multi-skilling manager circuitry 102 and multi-skill proficiency generation circuitry 103. The data structures and associations of the multi-skilling data system 500 provide flexibility for growth and modifications in the multi-skilling framework that functions as a tool for dynamically managing the ever changing demands of today's work force and work environments. Furthermore, the data structures and associations of multi-skilling data system 500 provide efficiencies such as reduced memory requirements and speedier access to information when monitoring and managing training information, proficiency assessment and the staffing of a skilled workforce, even when the workforce includes hundreds, thousands or tens of thousands of skilled professionals.

The participant data 510 may identify and define a participant enrolled in a multi-skilling program. The participant data 510 may be associated with the technology platform data 512 that defines a particular technology platform, and with the multi-skill role data 514 that may identify a particular multi-skill role defined for the technology platform data 512. The participant data 510 may also be associated with the multi-skill proficiency level data 526 that may be determined for the participant based on proficiency determination factors described with respect to FIGS. 3 and 4. The multi-skill role data 514 may be associated with the technology platform data 512 and with the skill IDs data 516 where the skill IDs data 516 may identify a plurality of skills used in the particular multi-skill role identified in the multi-skill role data 514. The skill IDs data 516 may be further associated with the skill tier data 518 and the skill class data 520. The skill class data 520 may classify the skills and the skill tier data 518 may prioritize the value of each of the plurality of skills represented in the skill IDs data 516, for example, for use in the calculation of a proficiency level for a participant.

Moreover, the participant data 510 and the multi-skill role data 514 may be associated with the core skills data 522, the mandatory skills data 524 and the elective skills data 526. The core skills data 522, the mandatory skills data 524 and the elective skills data 526 may comprise the skills from the skill IDs data 516 that are associated with the multi-skill role data 514 and are classified according to the skill class data 518.

The data represented in data system 500 and stored in the one or more databases 108, 110, 112 and 114 may be downloaded and utilized to create reports or user interactive displays. For example, user interactive screens or windows may be generated by the user interface circuitry 104 and may be sent to the one or more client devices 120 to be displayed in a web browser or another software generated tool. Exemplary user interactive screens may enable users to upload data and download data from the multi-skilling system 100 and the one or more databases 108, 110, 112 and 114. Other user interactive screens may display information about a participant's assigned technology platform, multi-skill role, multiple skills associated with the participant's role and the participant's proficiency level. Examples of user interactive GUI screens for a multi-skilling framework are described with respect to FIGS. 6-12.

Some user interactive screens may provide information about an employer's multi-skilling program, for example, users may be able to select, “click on” or hover over aspects of the multi-skilling program that are displayed within a window or screen, such as multi-skill roles, proficiency levels, skills or skill categories. In response, the user interactive screens may provide definitions about the selected items or provide tips relative to the multi-skilling program. Moreover, some screens may prescribe assignments or training for participants.

From the perspective of the employer or staffing manager, user interface screens may allow users to review multi-skilling data for one or a plurality of multi-skilled participants. For example, the user interactive screens may enable staffing of IT projects based on defined technology platforms, associated multi-skill roles and multi-skill proficiency scores. This may enable users to survey large populations of IT professionals (participants in the multi-skilling system) based on technology platforms, multi-skill roles and multi-skill proficiencies.

The user interactive screens may be displayed by the one or more client devices 120. Alternatively, data stored in the one or more databases 108, 110, 112 and 114 may be downloaded to the client devices 120 for similar use in user interactive client side software tools.

The multi-skilling methods, devices, processing, circuitry, structures, architectures, and logic described above may be implemented in many different ways and in many different combinations of hardware and software. For example, all or parts of the multi-skilling implementations may comprise circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the multi-skilling system circuitry may store or access instructions for execution, or may implement multi-skilling functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a multi-skilling computer program product, may include a storage medium and instructions stored in or on the medium, and the instructions when executed by the circuitry in a device may cause the device to implement any of the processing described above or illustrated in the drawings.

The multi-skilling implementations may be distributed. For instance, the multi-skilling circuitry may include multiple distinct system components, such as multiple processors and memories, and may span multiple distributed processing systems. Multi-skilling parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example multi-skilling implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

FIG. 6 is an illustration of an exemplary user interactive GUI screen for viewing or editing core skills, mandatory skills and elective skills in a multi-skilling framework. The interactive GUI screen may be utilized to configure the multi-skilling framework such that the multi-skilling framework data that is entered via the GUI screen may be configured within the system and data structures by associating or mapping a technology platform to core skills, associating a multi-skill role to mandatory skills and associating a participant to elective skills. The technology platform may be referred to as a capability or area of expertise and a multi-skill role may be referred to as a specialization or a role specialization.

In one embodiment, data that defines technology platforms, multi-skill roles, participants, core skills, mandatory skills, elective skills, proficiencies, proficiency weights and participant assessment information may be imported into the multi-skilling framework using, for example, a spread sheet or by entering data via any suitable user interface or web browser such as the GUI interface of FIG. 6. The imported or entered framework data may be stored in memory as configuration parameters and may be associated or mapped to other framework data in order to indicate relationships among the framework data items. For example, a participant identifier may be mapped to a technology platform identifier, a multi-skill role identifier, core skills identifiers, mandatory skills identifiers, elective skills identifiers, various skills assessment data and a multi-skill role proficiency level. In some embodiments, a graphical user interface may be provided to users such as system administrators and participants to enter data and configure the multi-skilling framework by entering new data or by modifying data already imported by spread sheets. For example, the GUI may be utilized to add new data items, remove data items, associate data items, update or change data items or to view the multi-skilling framework data.

Referring to FIG. 6, the interactive GUI screen may be displayed with pull down menus, interactive GUI elements and interactive icons that may facilitate management and generation of multi-skilling framework data. A user, for example a system administrator, may click on a capability pull down menu and may select a capability such as the Java Technology Platform capability displayed in a list of capabilities. As a result, the selected capability may be displayed in the capability box. One or more core skills associated with the selected capability may be displayed in a list along with interactive elements for editing the associated core skills list. For example, core skills may be added or removed from the list associated with the selected capability. A user may click on a core skill to select an existing skill to edit. A user may click on the “edit” element to add a new skill to the list, remove a selected skill from the list, or to enter information about a selected core skill and configure the core skills using the GUI. The user may click on a “see more” element to view and/or edit additional core skills.

Similarly, a user may click on a role specialization pull down menu and select a multi-skill role, for example, a Java Application Architect role, from a list of multi-skill roles. As a result, the selected multi-skill role may be displayed in the role specialization box. A plurality of mandatory skills associated with the selected multi-skill role may be displayed in a list along with interactive elements for editing the list of mandatory skills. For example, mandatory skills may be added or removed from the list associated with the selected multi-skill role. A user may click on a skill to select an existing skill to edit. The user may click on the “edit” element to add a skill, remove a selected skill from the list or to enter information about a mandatory skill and configure the mandatory skills using the GUI. The user may click on a “see more” element to view and/or edit additional mandatory skills.

Moreover, a user may view and edit a list of elective skills. A plurality of elective skills may be associated with a user. Elective skills may be displayed in a list along with interactive elements for editing the list. For example, elective skills may be added or removed from the list. A user may click on an elective skill to select it for editing. The user may click on the “edit” element to add a new elective skill, remove a selected elective skill from the list, associate the elective skill with a user, or to enter elective skill information and configure an elective skill using the GUI. The user may click on a “see more” element to view and/or edit additional elective skills.

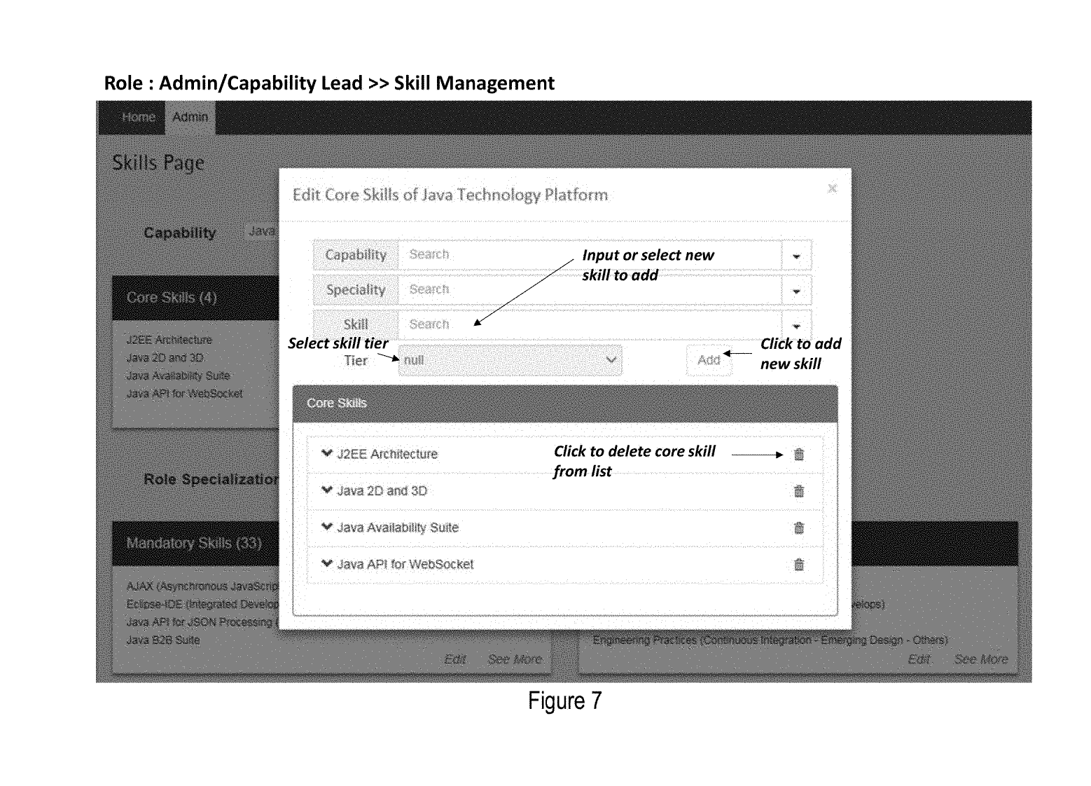

FIG. 7 is an illustration of an exemplary user interactive GUI screen for editing core skills in a multi-skilling framework. In some embodiments, the GUI screen shown in FIG. 7 may be accessed by clicking on the “edit” element of the “core skills” section of FIG. 6.

Referring to FIG. 7, a capability or technology platform may be selected by clicking on a drop down menu in the capability area. The system may filter core skills based on the selected technology platform and may display the filtered core skills in a list in the “core skills” section of the GUI screen. Otherwise, without a technology platform selection, a list of core skills for a plurality of technology platforms may be displayed in the “core skills” section.

A core skill may be added to the core skills list by selecting a core skill from a drop down menu, or a core skill may be added by typing in a skill name or identifier. The new core skill may be associated with a technology platform when a user selects a platform from the capability menu. A skill tier may be associated with the core skill when a user clicks on a tier pull down menu. The skill as specified by a user in the GUI screen may be configured in the system by clicking on an “add” GUI element. Moreover, when a list of core skills is displayed, a core skill may be removed from the list when a user clicks on an icon that corresponds to the skill to be removed. Moreover, further information about a listed a core skill may be accessed and displayed when a user clicks on an icon, such as a down arrow, that corresponds to the core skill.

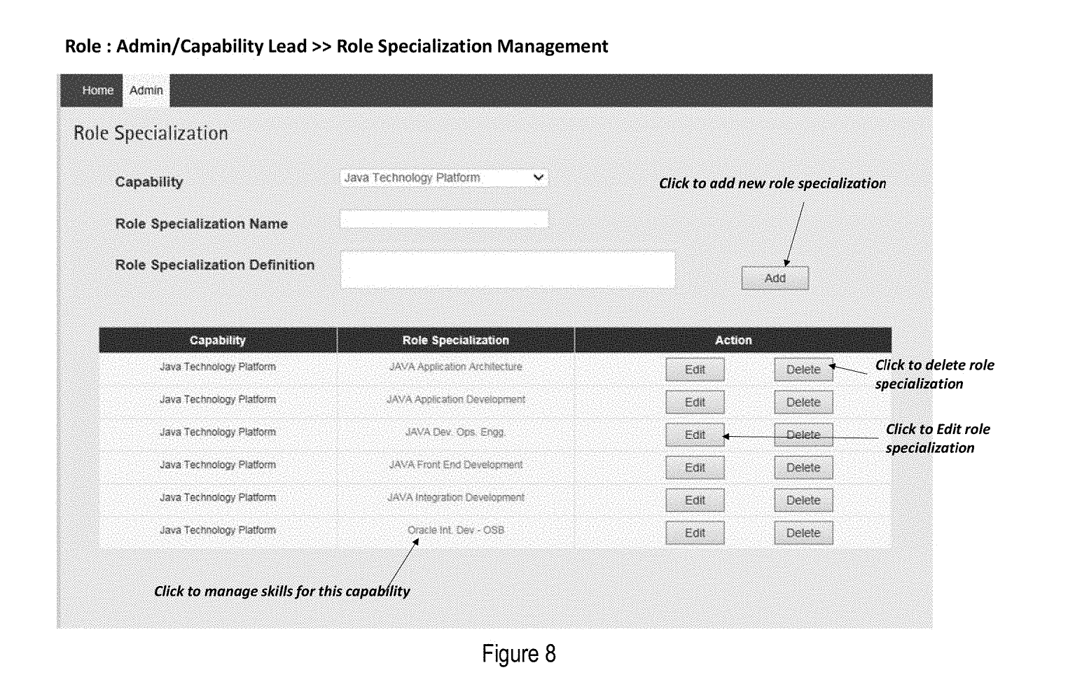

FIG. 8 is an illustration of an exemplary user interactive GUI screen for configuring multi-skill roles in a multi-skilling frame work. A multi-skill role may be referred to as a role specialization and a technology platform may be referred to as a capability.

Referring to FIG. 8, a role specialization GUI screen may list a plurality of capabilities and associated role specializations. GUI action elements may be provided for editing or deleting each listed role specialization where a user may remove or edit a multi-skill role by clicking on a remove or edit action element. Furthermore, multiple skills may be managed for each multi-skill role, for example, the skills may be defined, modified or assigned to a multi-skill role or capability, when a user clicks on a particular multi-skill role and opens an edit screen. Moreover, a new multi-skill role may be defined or configured for a technology platform when a user selects or clicks on a technology platform from a capability drop down menu to be associated with the new role. A name for the new multi-skill role and a corresponding definition for the new role may entered by the user in the GUI screen. The database may be updated to configure the multi-skilling framework with the new role information when the user clicks on an “add new role” GUI element.

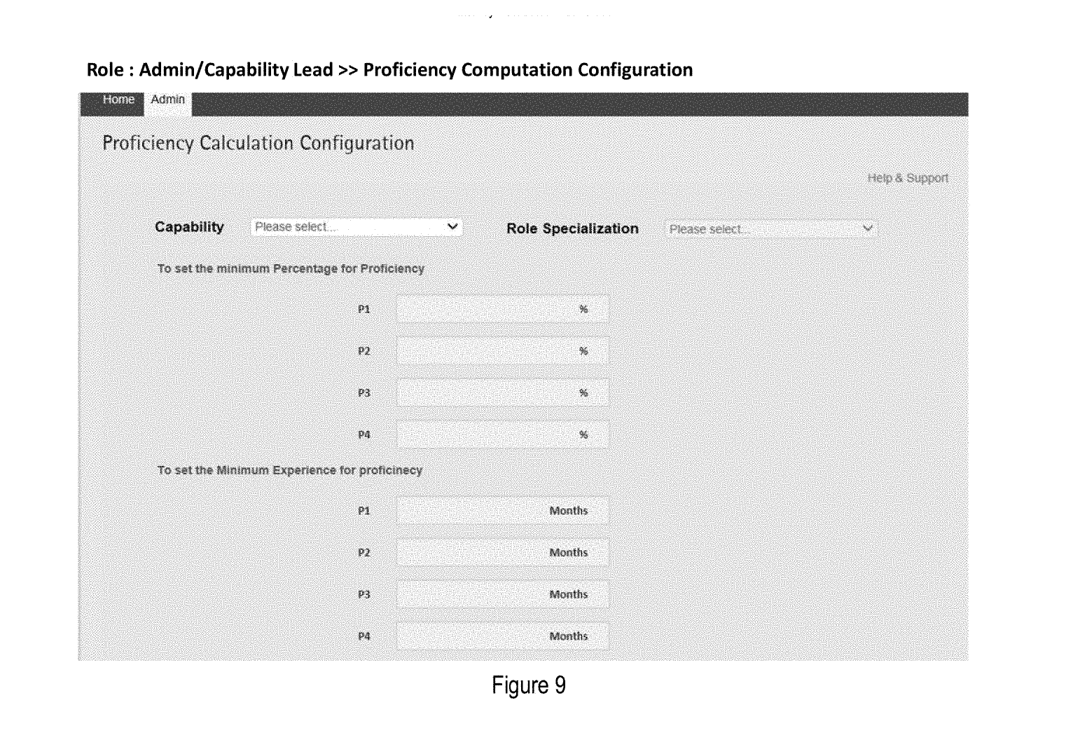

FIG. 9 is an illustration of an exemplary user interactive GUI screen for mapping skill assessment scores and experience to proficiency levels in a multi-skilling frame work. An overall proficiency score may be determined for each participant in a particular multi-skill role. The GUI screen shown in FIG. 9 may be utilized to configure a range of scores values and/or experience assigned to each proficiency level.

Referring to FIG. 9, proficiency level mapping parameters may be stored in a database when a user enters skill assessment and/or experience level values to correspond with respective proficiency levels in the GUI screen. For each multi-skill role within a technology platform, ranges of participant assessment scores or values may be mapped to proficiency levels. These mappings may be generated within the multi-skilling framework when a user selects a technology platform from a capability menu, selects one of the multi-skill roles that are associated with the technology platform from a role specialization drop down menu, and enters or selects a range of participant assessment scores for each proficiency level. For example, a user may enter a minimum score of 75% for a P1 proficiency level, a minimum score of 50% for a P2 proficiency level, a minimum score of 25% for a P3 proficiency level and 10% for a P4 proficiency level in the selected multi-skill role. In addition, for the selected multi-skill role and technology platform, ranges of a participant's time spent performing in the selected role or capability may be mapped to proficiency levels. For example, a user may enter a minimum experience period of 36 months for a P1 proficiency level, a minimum experience period of 24 months for a P2 proficiency level, a minimum experience period of 12 months for a P3 level and minimum experience period of 3 months for a P4 proficiency level. Once an assessment score and experience time for a participant is stored in a database, the multi-skilling framework may determine a proficiency level for the participant based on the proficiency level parameters.

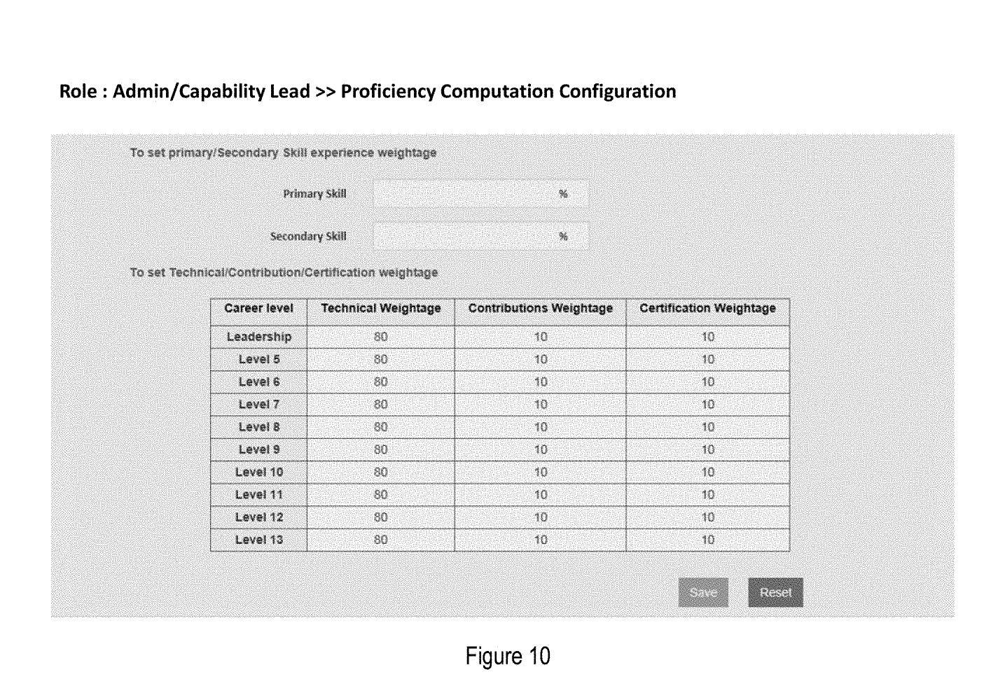

FIG. 10 is an illustration of an exemplary user interactive GUI screen for configuring weighting parameters for proficiency determination factors in one or more skills. Each factor that is utilized in a participant's proficiency level calculation may be weighted. Skills assessment data for participants may be imported into a database or entered into the database based on GUI screen input. The participant's skills assessment data may include information from different types of skills assessments including skill test scores, skill training certifications, hands-on skill assignments, contest results, years of experience performing a role or skill and technical contributions to a project, product or organization.

The GUI screen example shown in FIG. 10 may accept user input to configure weights applied to proficiency determination factors based. For example, skill assessment scores or assessment values that are associated with one skill may be weighted differently than those associated with another skill. In one embodiment, a user may enter a 75% weighting for a primary skill and a 25% weighting for a secondary skill. In some embodiments, the weightings applied per skill may be imported, for example, in a spread sheet.

Furthermore, the GUI screen example shown in FIG. 10 may accept user entry of different weight values that may be configured to apply to different types of skill assessment data when the multi-skilling framework calculates a proficiency level for a participant in a multi-skill role. For example, skills may be assessed using technical expertise test scores, contributions made to an organization or product development and certifications for successful completion of technical training. These types of skill assessments may correspond to the column headers of FIG. 9, including technical weightage, contributions weightage and certification weightage respectively. Furthermore, the weightings may be varied according to any suitable category, such as career level, employment position or years of experience. The row headings in FIG. 10 refer to career level categories that may each be associated in the database with different weight values for each of the various types of skill assessments.

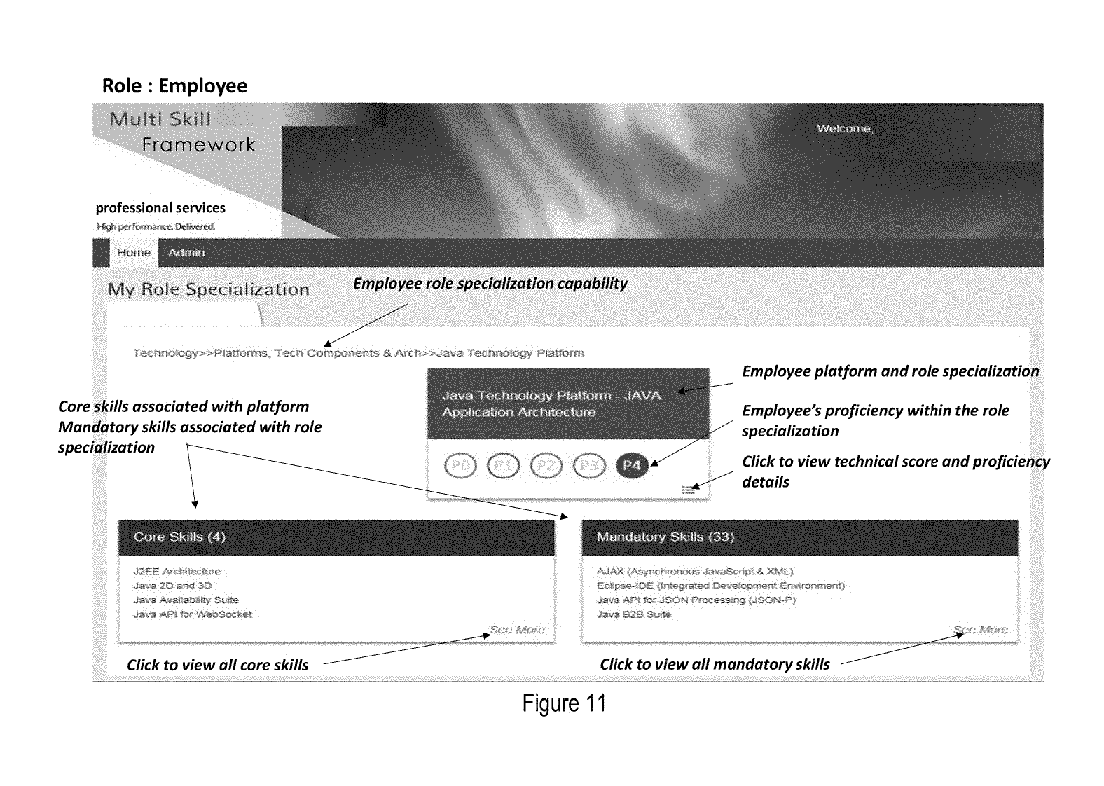

FIG. 11 is an illustration of an exemplary user interactive GUI screen for display of a participant's multi-skill profile. The GUI screen shown in FIG. 11 may be viewed by a user, for example, a participant in the multi-skilling framework. The display may identify a participant and may identify the participant's assigned technology platform and assigned multi-skill role within the identified technology platform. Furthermore, the GUI screen may display the participant's proficiency level within their multi-skill role. In some embodiments, the GUI screen may display core skills associated with the participant's technology platform, mandatory skills associated with the participant's multi-skill role and may include elective skills associated with the participant.

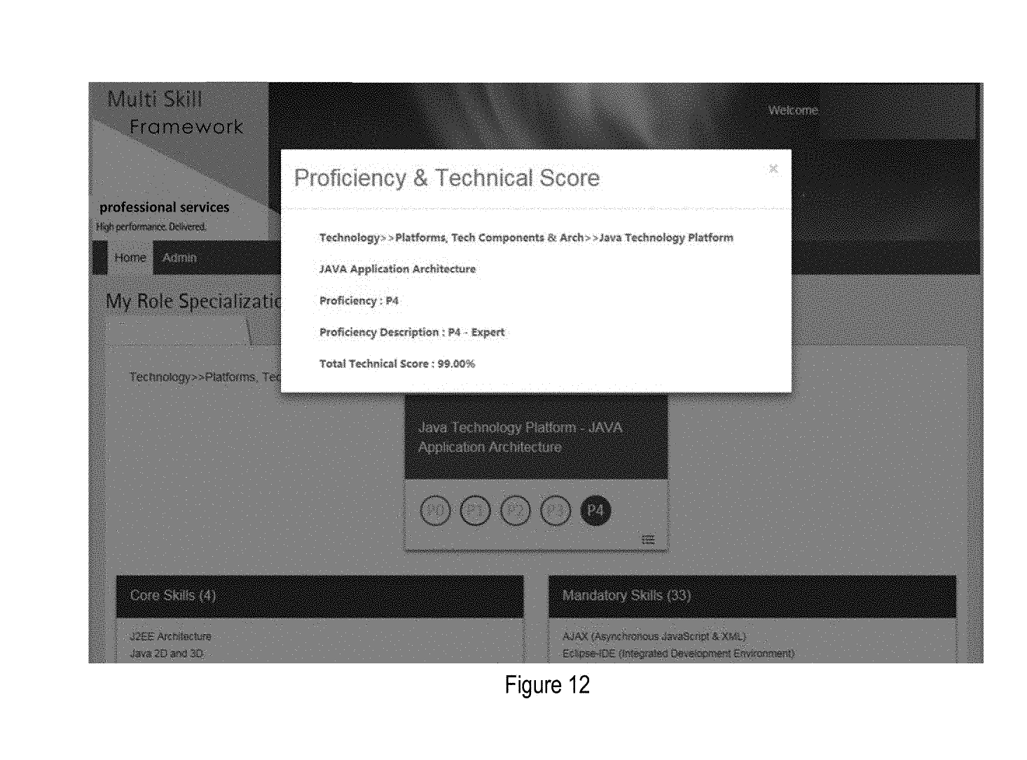

The GUI may provide interactive elements or icons for displaying additional information related to, for example, assessment information, proficiency details and additional core, mandatory or elective skills information. For example, a user may click on an interactive element associated with the identified participant's proficiency level to open a window that displays more detailed proficiency and technical score information. See FIG. 12 for an example of a proficiency and technical score GUI screen window that may be opened for the identified participant by clicking an interactive element in the FIG. 11 GUI screen.

Additional interactive GUI screens may be provided for searching, displaying and configuring the multi-skill framework data. For example, GUI screens may be provided for use by staffing managers who may utilize the multi-skilling framework tool to identify multi-skilled individuals for employment or technical projects. The interactive GUI screens may enable the staffing manager to filter participant data in order to identify and analyze candidates for multi-skill roles and to assign the participants to their respective positions. The interactive GUI staffing screens may enable a user to filter participants based on one or more of technology platform, multi-skill role, proficiency level and other data stored in the multi-skilling frame work such as elective skills, resume items or other proficiency determination factors.

Various multi-skilling implementations have been specifically described. However, many other implementations are also possible. See Appendix A for additional information, which is included herewith as part of this specification.

We claim:

1. A multi-skilling framework system comprising:
a processor;
a communication interface operatively coupled with the processor; and
a storage medium in communication with the processor, the storage medium having stored thereon:
definition data for each of a plurality of technical platforms;
definition data for each of a plurality of multi-skill roles, each one of the plurality of multi-skill roles is associated with one of the plurality of technical platforms;
definition data for a plurality of skills, wherein each of the plurality of multi-skill roles is associated with a respective number of the plurality of skills;
mapping data that maps each one of a plurality of users with one of the plurality of multi-skill roles and an associated one of the plurality of technical platforms;
skills assessment data for each respective one of the plurality of users;
definition data for multi-skill proficiency determination factors for each respective one of the plurality of multi-skill roles;
instructions executable by the processor that when executed by the processor cause the processor to:
effect a user interface to receive and store:
the definition data for the plurality of technical platforms;
the definition data for the plurality of multi-skill roles;
the definition data for the plurality of skills;
the mapping data;
the skills assessment data and
the definition data for the multi-skill proficiency determination factors;
determine a respective multi-skill proficiency level for each one of the plurality of users; and
effect display of a graphical representation for one or more of the plurality of users, the graphical representation including:
a respective multi-skill proficiency level determined for each one of the one or more of the plurality of users;
a respective multi-skill role mapped to each one of the one or more of the plurality of users;
a respective technology platform associated with the respective mapped multi-skill role; and
a respective plurality of associated skills for each one of the one or more of the plurality of users.

2. The multi-skilling framework system of claim 1 wherein each one of the plurality of users is associated with a number of the plurality of skills based on which of the plurality of multi-skill roles is mapped to the respective user and which of the plurality of technology platforms is associated with the respective user.

3. The multi-skilling framework system of claim 1 wherein the respective multi-skill proficiency level determined for each one of the plurality of users is determined based on the skills assessment data for each respective user and the multi-skill proficiency determination factors corresponding to the multi-skill role mapped to each respective user.

4. The multi-skilling framework system of claim 1 wherein the skills assessment data includes information from different types of skills assessments including skill test scores, skill training certifications, hands-on skill assignments; contest results and technical asset contributions.

5. The multi-skilling framework system of claim 4, wherein the skills assessment data from the different types of skills assessments is weighted differently according to the definition data for multi-skill proficiency determination factors.

6. The multi-skilling framework system of claim 1, wherein the respective multi-skill proficiency determined for each one of the plurality of users is determined according to the technology platform associated with the respective user and the multi-skill role mapped to the respective user.

7. The multi-skilling framework system of claim 1 wherein the effected display of a graphical representation for one or more of the plurality of users includes:
the respective multi-skill proficiency level determined for each one of the one or more of the plurality of users;
the respective multi-skill role mapped to each respective user;
the technology platform associated with each respective user; and
the plurality of skills associated with each respective user.

8. The multi-skilling framework system of claim 1 wherein spreadsheets are utilized to import one or more of:
the definition data for each of the plurality of technical platforms;
the definition data for each of the plurality of multi-skill roles;
the definition data for the plurality of skills;
the mapping data that maps each of a plurality of users;
the skills assessment data for each one of the plurality of users; and
the definition data for multi-skill proficiency determination factors.

9. The multi-skilling framework system of claim 1 further comprising recommending via the user interface, specified skill training for one of the plurality of users based on the respective user's skill assessment data.

10. A method for implementing a multi-skilling framework system, the method comprising:
importing and storing in a memory by multi-skilling manager circuitry:
definition data for each of a plurality of technical platforms;
definition data for each of a plurality of multi-skill roles, each one of the plurality of multi-skill roles being associated in the memory with one of the plurality of technical platforms;
definition data for a plurality of skills, wherein each of the plurality of multi-skill roles is associated in the memory with a respective number of the plurality of skills;
mapping data that maps each of a plurality of users with one of the plurality of multi-skill roles and an associated one of the plurality of technical platforms;
skills assessment data for each one of the plurality of users; and
definition data for multi-skill proficiency determination factors for each of the plurality of multi-skill roles;
effecting by user interface circuitry a user interface to import and store in the memory:
the definition data for the plurality of technical platforms;
the definition data for the plurality of multi-skill roles;
the definition data for the plurality of skills;
the mapping data;
the skills assessment data; and
the definition data for the multi-skill proficiency determination factors;
determining a respective multi-skill proficiency level for each one of the plurality of users based on data stored in the memory; and
effecting digital display of a graphical representation for one or more of the plurality of users, the graphical representation including:
a respective multi-skill proficiency level determined for each one of the one or more of the plurality of users;
a respective multi-skill role mapped to each one of the one or more of the plurality of users;
a respective technology platform associated with the respective mapped multi-skill role; and
a respective plurality of associated skills for each one of the one or more of the plurality of users.

11. The method of claim 10 wherein each one of the plurality of users is associated with a number of the plurality of skills based on which of the plurality of multi-skill roles is mapped to the respective user and which of the plurality of technology platforms is associated with the respective user.

12. The method of claim 10 wherein the multi-skill proficiency level determined for each one of the plurality of users is determined based on the skills assessment data for each respective user and the multi-skill proficiency determination factors corresponding to the multi-skill role mapped to each respective user.

13. The method of claim 10 wherein the skills assessment data includes information from different types of skills assessments including skill test scores, skill training certifications, hands-on skill assignments; contest results and technical asset contributions.

14. The method of claim 13, wherein the skills assessment data from the different types of skills assessments is weighted differently according to the definition data for multi-skill proficiency determination factors.

15. The method of claim 10 wherein the multi-skill proficiency determined for each one of the plurality of users is determined according to the technology platform associated with the respective user and the multi-skill role mapped to the respective user.

16. The method of claim 10 wherein the effected display of a graphical representation for one or more of the plurality of users includes:
the multi-skill proficiency level determined for each respective user;
the multi-skill role mapped to each respective user;
the technology platform associated with each respective user; and
the plurality of skills associated with each respective user.

17. The method of claim 10 wherein spreadsheets are utilized to import one or more of:
the definition data for each of the plurality of technical platforms;
the definition data for each of the plurality of multi-skill roles;
the definition data for the plurality of skills;
the mapping data that maps each of a plurality of users;
the skills assessment data for each one of the plurality of users; and
the definition data for multi-skill proficiency determination factors.

18. The method of claim 10 further comprising recommending via the user interface circuitry, specified skill training for one of the plurality of users based on the respective user's skill assessment data.

19. A method comprising:
in a multi-skilling system comprising one more processors that are coupled to a memory and communication interface:
registering a user into a technology platform group;
assigning a particular multi-skill role within the technology platform group to the user;
identifying for the user, multiple skills pertaining to the assigned multi-skill role and the technology platform;
assigning training to the user to develop the identified multiple skills and knowledge pertaining to the assigned multi-skill role;
assigning hands-on assignments to the user to develop the identified multiple skills and knowledge pertaining to the assigned multi-skill role;
obtaining assessment data measuring the user's identified multiple skills and knowledge pertaining to the assigned multi-skill role; and
determining a total multi-skill proficiency score for the user relative to the assigned multi-skill role based on the assessment data.

20. The method of claim 19 wherein the assessment data is based on data representing:
skills test scores;
training certifications;
participation in skill demonstration events, assignments and contests; and
technical contributions made by the user to an organization.
